(19) United States
(12) Patent Application Publication
(10) Pub. No.: US 2026/0183906 A1
(43) Pub. Date: Jul. 2, 2026

(54) QUICK CONNECT STACK DRIVE FOR LIMITED CLEARANCE TOOL

(71) Applicant: Primesource Consulting LLC, Herriman, UT (US)

(72) Inventor: John Davis, Herriman, UT (US)

(21) Appl. No.: 19/436,301

(22) Filed: Dec. 30, 2025

Related U.S. Application Data
(60) Provisional application No. 63/740,371, filed on Dec. 31, 2024.

(51) Int. Cl. B25B 13/48; B25B 21/00

(52) U.S. Cl. CPC B25B 13/481; B25B 21/002

(57) ABSTRACT

A stack drive assembly includes a socket configured to slidingly engage an associated nut so as to define a socket axis. The socket engages the associated nut for paired rotational movement. A drive shape and a drive size of the driver are the same as the nut shape and the nut size of the associated nut. The driver is rotationally coupled to the socket. The stack drive assembly also includes at least one lock ring that is rotationally independent from the driver. The at least one lock ring is configured for engagement with an associated engagement portion of an associated torque tool. The driver is configured to rotate with respect to the at least one lock ring while the at least one lock ring does not rotate.

### BACKGROUND

Power driven torque tools generate an accurate bolt load through the rotation of a fastener. A reaction washer can be used to provide an abutment means for the tool. In particular, the reaction washer is placed directly below the nut or bolt head being subjected to the intended tightening force. Further, the reaction washer is connected to the tool housing via a stack drive assembly. This connection ensures that the tightening force generated by the tool is transferred into the fastener and does not merely result in rotation of the tool around the axis of the fastener.

However, there are difficulties associated with these tools and traditional reaction washers. For example, the reaction washer and stack drive assembly may need to be used in a horizontal or inverted position. When these orientations are present, the connection between the reaction washer and socket can be compromised. Traditional reaction washers do not provide a positive connection means to the socket allowing for a safe, hands-free operation of the power driven torque tool. Further, the socket might not mate with the corresponding power-driven torque tool due to connection differences between the power driven torque tool body and the receiving end of the socket.

Bolted assemblies are often in an inverted condition in which the weight of the tooling needed to perform the work become dangerous. This condition can be compounded by the length the threaded rod which could extend past the nut and/or washer making the use of an open-ended limited clearance required.

With the introduction of a reaction washer which has the ability to connect to it through a positive receiving geometry on the washer, there creates a need to not only connect to the bolted assembly (via the washer) in an inverted condition, so as to allow extended length fasteners such as threaded rods to pass through to tool opening, and then allow for a quick, safe and fast connection means by which the dangerous weight of the tooling can be suspended from the bolted assembly safely.

This present disclosure solves this issue as it can be placed onto the bolted assembly in pieces to reduce the weight of the entire assembly into individual sub-assemblies for ease of handling, use and operation.

### SUMMARY

According to an aspect, a stack drive assembly includes a socket configured to slidingly engage an associated nut so as to define a socket axis. The socket engages the associated nut for paired rotational movement. The stack drive assembly also includes a driver defining a drive shape and a drive size and the associated nut defining a nut shape and a nut size. The drive shape and the drive size of the driver are the same as the nut shape and the nut size of the associated nut. The driver is rotationally coupled to the socket. The stack drive assembly also includes at least one lock ring that is rotationally independent from the driver. The at least one lock ring is configured for engagement with an associated engagement portion of an associated torque tool. The driver is configured to rotate with respect to the at least one lock ring while the at least one lock ring does not rotate.

### BRIEF DESCRIPTION OF THE DRAWINGS

FIG. 1 is a perspective view of a quick connect stack drive assembly in an operating environment;

FIG. 2 is a perspective view of the stack drive assembly of FIG. 1;

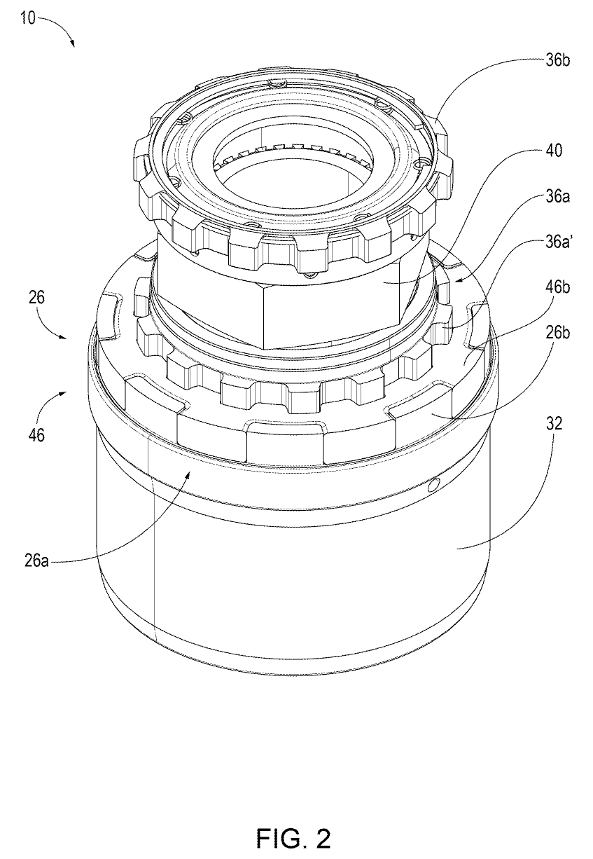

FIG. 3 is a sectional view of the stack drive assembly;

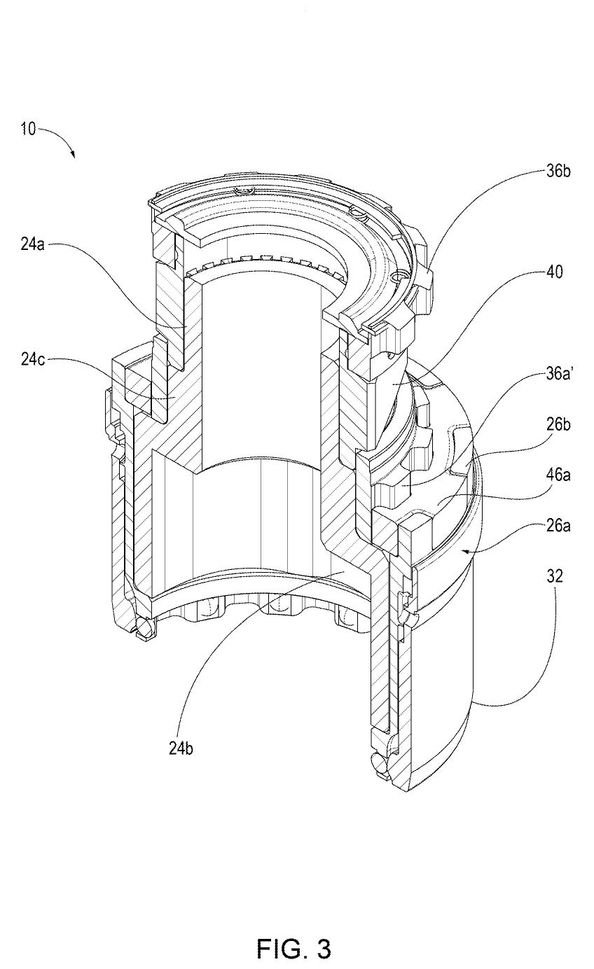

FIG. 4 is a bottom plan view of the stack drive assembly;

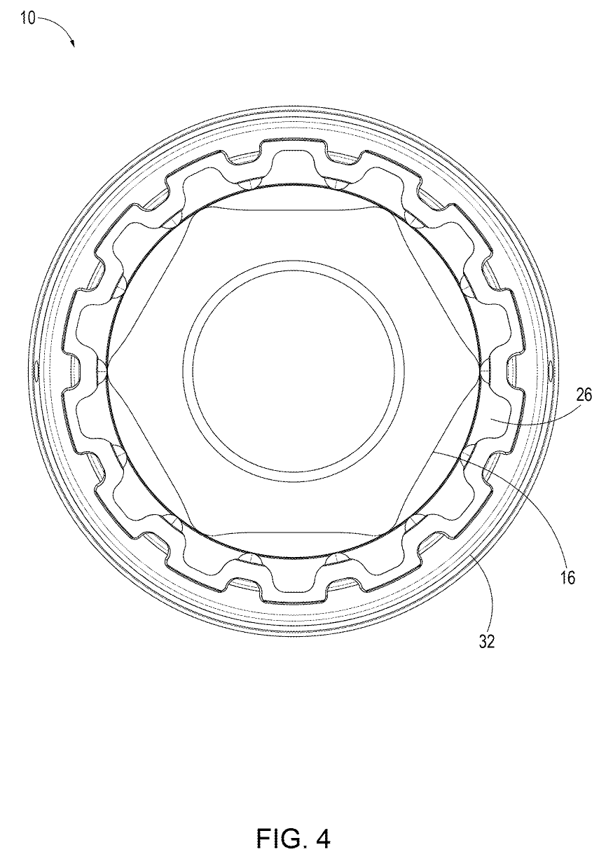

FIG. 5 is a top plan view of the stack drive assembly;

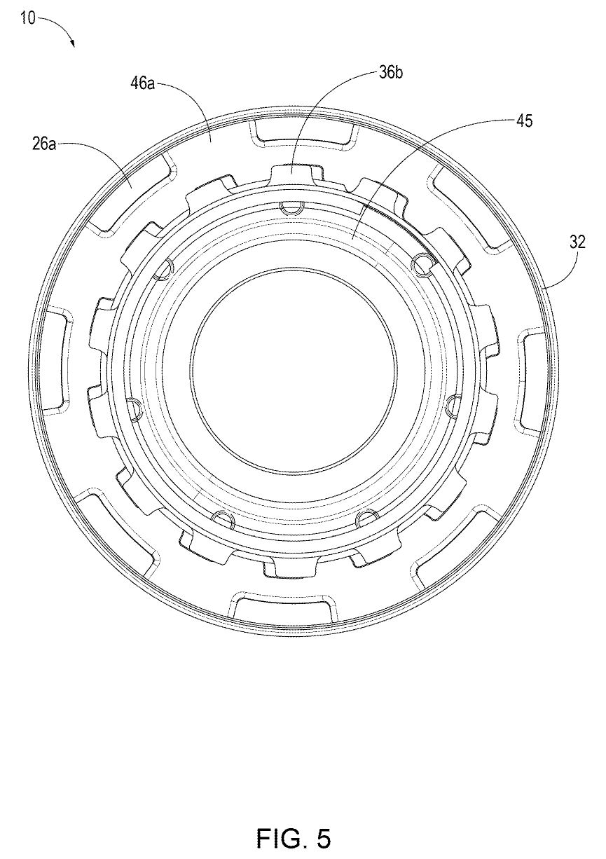

FIG. 6 is an exploded top perspective view of the stack drive assembly;

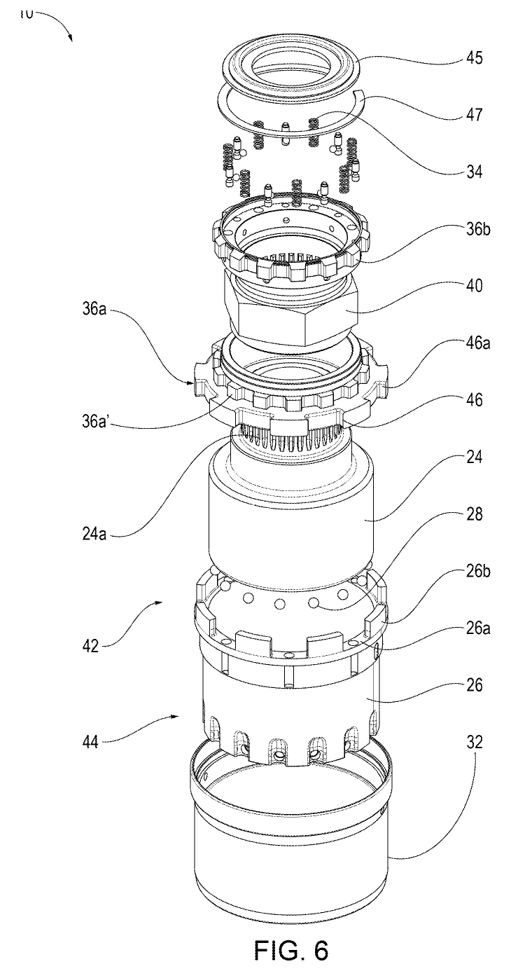

FIG. 7 is an exploded bottom perspective view of the stack drive assembly;

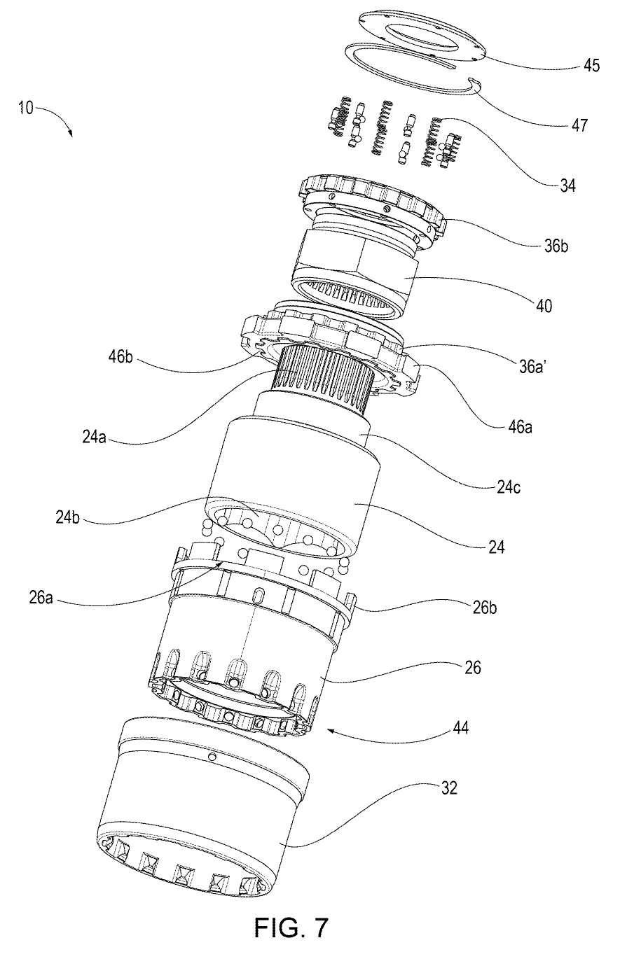

FIG. 8 is an exploded bottom perspective view of the stack drive assembly with a sleeve removed; and

FIG. 9 is an exploded top perspective view of the stack drive assembly with the sleeve removed.

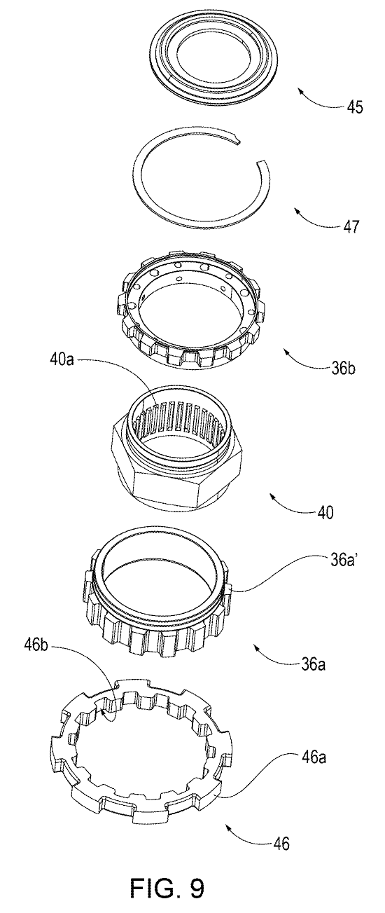

### DETAILED DESCRIPTION

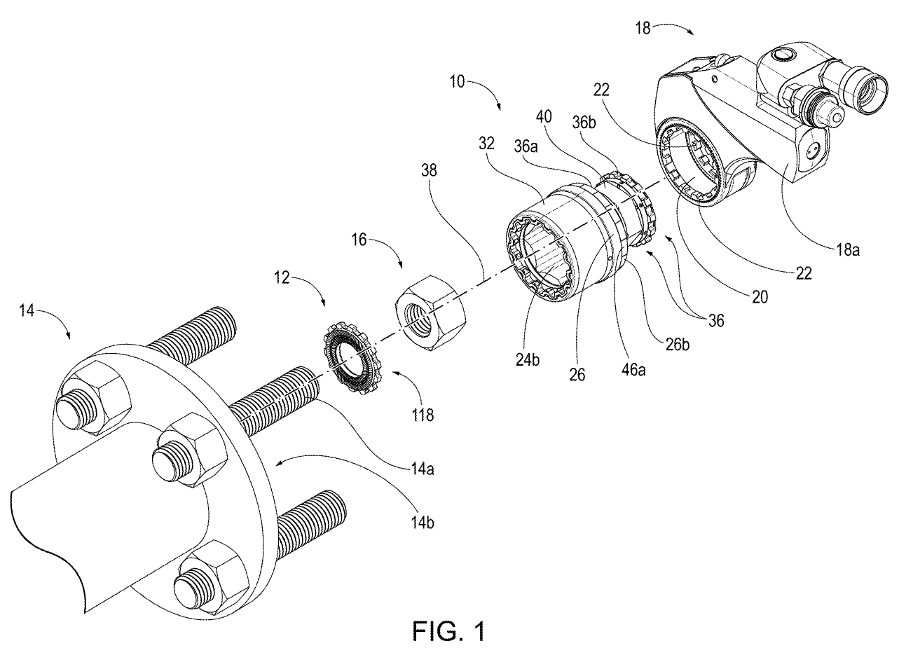

With reference to FIG. 1, a stack drive assembly 10 can be used with a variety of components to engage a reaction washer 12 that is slidingly received on associated threaded element 14a that contacts a flange face 14b of a flange assembly 14 and an associated nut 16 that is threadingly received on the associated threaded element 14a.

As illustrated, the stack drive assembly 10 can be used with an associated torque tool 18 with a frame 18a. The torque tool 18 can include a driver portion 20 that selectively rotates. When used with the stack drive assembly 10, the driver portion 20 can directly engage with the driver 40 so that they are rotationally coupled together. When the torque tool 18 is not used with the stack drive assembly 10, the driver portion 20 can directly engage with the associated nut 16 so that they are rotationally coupled together.

The torque tool 18 can also include an engagement portion 22 to engage the stack drive assembly 10. As illustrated, the torque tool 18 includes two engagement portions 22. It is noted that engagement portion 22 can be separable from the torque tool 18. For example, it is envisioned that the engagement portion 22 could be applied to a torque tool that was not originally supplied with such an engagement portion. Further, the stack drive assembly 10 can simultaneously engage the reaction washer 12 and nut 16 so as to rotationally link them together. The threaded element 14a could be part of a bolt or stud that is threadingly engaged by the nut 16. The reaction washer 12 is disposed on the threaded element 14a so that the nut 16 is between the reaction washer 12 and the free end of the threaded element 14a along a socket axis 38 so as to engage the torque tool 18 as will be described in more detail hereinafter.

Notably, the reaction washer 12 can slidingly and coaxially receive the threaded element 14a and the nut 16 can threadingly and coaxially receive the threaded element 14a, both along the socket axis 38. As noted hereinbefore, the torque tool 18 can be utilized to tighten or loosen the nut 16. As will be appreciated, this means that the nut 16 would travel along the threaded element 14a toward the free end of the threaded element 14a when the nut 16 is being loosened so that the nut 16 could be removed from the threaded element 14a and the nut 16 would travel along the threaded element 14a away from the free end of the threaded element 14a when the associated threaded element 14a is being tightened so that the nut 16 cannot be removed from the threaded element 14a.

The flange 14 either receives or is attached to the threaded element 14a distal to the free end so as to provide a surface to which the reaction washer 12 and the nut 16 can be tightened (i.e., preventing linear movement of the reaction washer 12 and the nut 16 along the socket axis 38 away from the free end). Further, serrations of the reaction washer 12 prevent rotation of the reaction washer 12 around the threaded element 14a.

The stack drive assembly 10 can include a socket 24, a lower part 26, a plurality of keys 28, and a sleeve 32. Additionally, the stack drive assembly 10 can also include at least one resiliently resistive element 34, at least one lock ring 36, a driver 40, and an interlock sleeve 46. The stack drive assembly 10 can also include a bushing 45 and a retaining ring 47.

The socket 24 is configured to slidingly engage the associated nut 16 so as to define a socket axis 38. As will be appreciated, the socket 24 would rotate about the socket axis 38 when driven by the torque tool 18. As such, the socket 24 engages the associated nut 16 for paired rotational movement. The socket 24 is configured to rotationally move independent of the lower part 26.

The socket 24 can include an upper end and a lower end disposed at opposite ends thereof along the socket axis 38. The lower end of the socket 24 defines a maximum outer diameter of the socket 24 and the upper end of the socket 24 defines a minimum outer diameter of the socket 24. The socket 24 also includes a shoulder portion 24c that defines a shoulder outer diameter that is less than the maximum outer diameter and greater than the minimum outer diameter.

The upper end defines a plurality of socket splines 24a primarily extending in a direction along the socket axis 38. The plurality of socket splines 24a are disposed on an exterior of the upper end of the socket 24. The socket splines 24a can engage the driver splines 40a as will be described in more detail hereinafter. This splined engagement provides an positive connection between the elements. An interior of the lower end of the socket 24 defines a plurality of surfaces 24b that are angularly offset from one another about the socket axis 38 so as to engage the associated nut 16. As illustrated, the socket 24 defines a generally cylindrical outer diameter and is a 12-point socket. However, it will be appreciated that other shapes are possible and contemplated without departing from the scope of this disclosure.

The lower part 26 can be disposed coaxially exterior to the socket 24. The lower part 26 can have a generally cylindrical shape with a top 42 and a bottom 44 disposed at opposite ends thereof along the socket axis 38. The lower part 26 can include a plurality of tabs 26b that upwardly extend from the top 42 so as to define a plurality of recesses 26a therebetween for receipt of the plurality of exterior teeth 46a of the interlock sleeve 46 so as to prevent relative rotation between the lower part 26 and the interlock sleeve 46. A number of the plurality of recesses 26a of the lower part 26 can be equal to a number of the plurality of exterior teeth 46a. Such an arrangement between the lower part 26 and the interlock sleeve 46 ensure a robust engagement between the components.

The lower part 26 can define a lower part inner diameter surface and a plurality of slots. The slots can extend primarily in a direction parallel to the socket axis 38. Further, the slots can be disposed within the lower part 26 and adjacent the bottom 44 of the lower part 26. The slots can extend from the bottom 44 toward the top 42. It is envisioned that the slots will only extend partially upward toward the top 42 a distance that is approximately equal to the thickness of the reaction washer 12. However, it will be appreciated that that the length of the slots could be of a variety of lengths without departing from the scope of this disclosure. The slots of the lower part 26 engage the lobes of the reaction washer 12. This engagement provides for improved operation of the reaction washer 12 and the stack drive assembly 10. Notably, the locking elements 118 and the lobes load share a rotational force induced into the reaction washer 12 so as to provide a major diameter load distribution and a minor diameter load distribution of forces.

The slots of the lower part 26 can engage the reaction washer 12. The lower part 26 can also define a plurality of open channels that extend in a direction generally parallel to the socket axis 38 for receipt of the least one resistive element 34. As will be appreciated, the open channels are sized to allow at least partial receipt of the at least one resistive element 34. Notably, the open channels can be sized such that a radial portion of the resistive element 34 is not received within the open channels so that the sleeve 32 and the lower part 26 can be biased away from one another. The at least one resistive element 34 can be retained within the open channels with the bushing 45 and the retaining ring 47. As illustrated, the bushing 45 is circular and the retaining ring 47 is a C-clip. However, other shapes are possible and contemplated.

The lower part 26 can also define a plurality of recesses and a plurality of keyways. As illustrated, the recesses and keyways are disposed near the bottom 44 of the lower part 26 and are radially disposed about the lower part 26. Further, the recesses can extend primarily in a direction parallel to the socket axis 38 and the keyways can extend primarily in a direction radially extending toward the socket axis 38.

The plurality of recesses are fluidly connected with the respective plurality of keyways. Additionally, the plurality of keyways fluidically connect the sleeve 32 and the socket 24. The lower part inner diameter surface defines a plurality of engagement ports in direct fluid communication with the respective keyways. More particularly, the engagement ports can serve as a fluidic gateway to the keyways. Further, the engagement ports can be sized to limit radial travel of the keys 28 toward the socket axis 38.

As illustrated, the keys 28 are generally spherical in shape. The spherical shape allows the keys 28 to smoothly and precisely move within the recesses and the keyways for enhanced engagement with the reaction washer 12. However, it will be appreciated that other shapes are possible without departing from the scope of the disclosure. As will be discussed in more detail hereinafter, the plurality of keys 28 can at least partially extend radially inward toward the socket axis 38 when a respective plurality of ramps of the sleeve 32 are received in the respective plurality of recesses of the lower part 26. However, as was previously noted, the size of the engagement ports limit the radial movement of the keys 28 toward the socket axis 38.

The plurality of keys 28 are selectively disposed in the plurality of recesses and the plurality of keyways. The lower part 26 and the plurality of keys 28 are configured to simultaneously engage the reaction washer 12 so as to prevent rotation about the socket axis 38 between the lower part 26, the plurality of keys 28, and the associated reaction washer 12. Notably, as will be described hereinafter, the keys 28 engage locking elements 118 of the reaction washer 12.

The sleeve 32 can be disposed coaxially exterior to the lower part 26. The sleeve 32 can be of a generally cylindrical shape and include the plurality of ramps that are selectively received in the plurality of recesses. The sleeve 32 can define a sleeve inner diameter surface from which the plurality of ramps radially extend inward.

Further, the sleeve 32 can include a first end and a second end. The first end and the second end can be disposed at opposite ends of the sleeve 32. Additionally, the second end of the sleeve 32 can define a second end inner diameter surface that circumferentially surrounds the lower part 26. The second end inner diameter surface can define a sleeve shape and a sleeve size.

The stack drive assembly 10 can define an engaged position when the respective plurality of ramps of the sleeve 32 are received in the respective plurality of recesses of the lower part 26 and an unengaged position when the respective plurality of ramps of the sleeve 32 are not received in the respective plurality of recesses of the lower part 26. In the engaged position, the keys 28 at least partially extend through the keyways, and more particularly through the engagement ports toward the socket axis 38. Thus, the keys 28 can be at least partially received in, and engage, the locking elements 118 of the reaction washer 12.

Further, the engaged position provides for a hands-free connection between the associated reaction washer 12 and the stack drive assembly 10. In contrast, in the unengaged position, the keys 28 do not extend through the engagement ports toward the socket axis 38. Thus, the keys 28 are not received in, and do not engage, the locking elements 118 of the reaction washer 12.

The at least one resiliently resistive element 34 can be disposed between the sleeve 32 and the lower part 26. As noted hereinbefore, the at least one resistive element 34 can be received in the open channels. As illustrated, there are a plurality of resistive elements 34. Further, the resistive elements 34 are shown as coil springs. However, it will be appreciated that other types of resistive elements are possible and contemplated without departing from the scope of the disclosure. Functionally, the resistive element 34 can bias the sleeve 32 and the lower part 26 away from one another along the socket axis 38 for improved operation of the stack drive assembly 10.

The at least one lock ring 36 can include a first lock ring 36a and a second lock ring 36b that are spaced from one another along the socket axis 38. More or less lock rings are envisioned. For simplicity, any reference to the at least one lock ring 36 will be understood to reference the first lock ring 36a unless noted otherwise. The at least one lock ring 36 can be configured for engagement with the associated torque tool 18 such that the at least one lock ring 36 does not spin with respect to the engagement portion 22 of the associated torque tool 18. Such an arrangement allows the user of the torque tool 18 to more easily drive the nut 16.

The at least one lock ring 36 defines a lock ring inner diameter that is greater than the outer diameter of the shoulder potion 24c so that the shoulder portion of the socket 24 can coaxially pass through the at least one lock ring 36. Further, the socket 24 is rotationally independent from the at least one lock ring 36 and the at least one lock ring 36 is rotationally independent from the driver 40. Because of the aforementioned features, the stack drive assembly 10 is compatible with threaded elements 14a of an infinite length.

The at least one lock ring 36 can have a generally annular shape. Further, the lock rings 36 can be of a same shape and size as the washer 12. However, it is envisioned that the at least one lock ring 36 does not have to be the same size and shape as the washer 12. In instances when the at least one lock ring 36 is the same shape and size as the washer 12, the torque tool 18 can be used with or without the stack drive assembly 10. The at least one lock ring 36 defines a lock ring inner diameter. It is envisioned that in some circumstances that the lock ring inner diameter will permit passage of the associated threaded element 14a that threadingly receives the associated nut 16. However, in other circumstances, the lock ring inner diameter may be sized such that passage of the associated threaded element 14a is not possible.

The at least one lock ring 36 can include a plurality of castles 36a’ that radially extend outward. The plurality of castles 36a’ of the at least one lock ring 36 (i.e., 36a) are configured to engage the lower part 26 and the associated engagement portion 22 of the associated torque tool 18.

The driver 40 can define a drive shape and a drive size and the associated nut 16 can define a nut shape and a nut size. As will be appreciated, the associated nut 16, and hence the driver 40, could be a variety of sizes and shapes without departing from the scope of this disclosure. Notably, the nut 16, and hence the driver 40 could be any number of polygonal shaped elements. Further, the drive shape and the drive size of the driver 40 can be the same as the nut shape and the nut size of the associated nut 16. Thus, special adapters are not needed to utilize the torque tool 18. The driver 40 can disposed along the socket axis 38 so as to be between the first lock ring 36a and the second lock ring 36b.

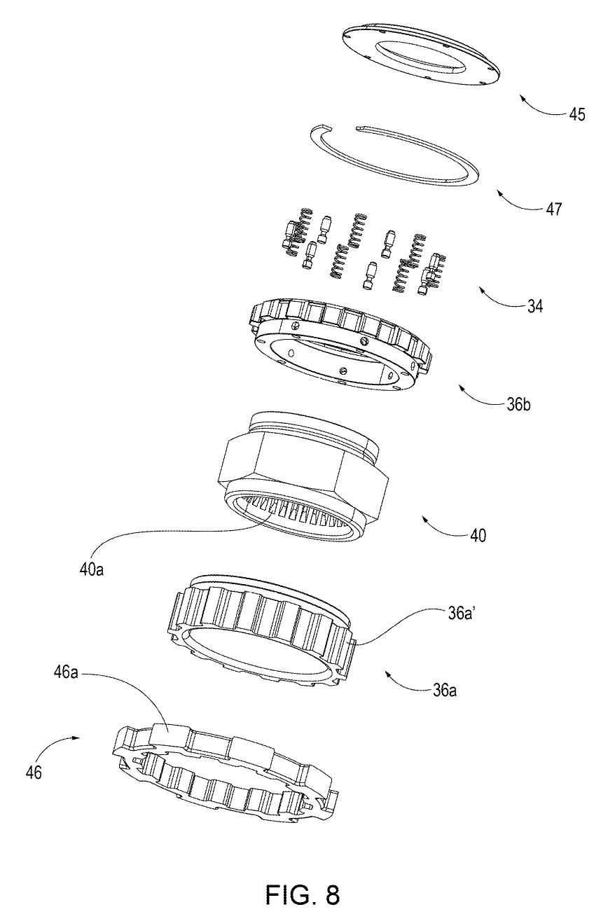

As shown in FIG. 8, the driver 40 includes an interior face that defines a plurality of drive splines 40a that slidingly engage the plurality of socket splines 24a of the upper end of the socket 24 so as to rotationally couple the driver 40 and the socket 24 together. Thus, the driver 40 and the socket 24 are rotationally coupled together. Thus, when the torque tool 18 rotates the driver 40, the socket 24 is also rotated. As such, the stack drive assembly 10 rotationally couples the associated nut 16 to the torque tool 18 so that when the driver 40 is rotated by the torque tool 18, the associated nut 16 is also rotated. Further, the upper end of the socket 24 is disposed coaxially interior to the driver 40.

The lock rings 36 of the stack drive assembly 10 are configured to engage the engagement portion 22 of the associated torque tool 18. Thus, the lock rings 36 and the engagement portion 22 do not rotate when the socket 24 and nut 40 are rotating. Stated another way, the driver 40 is configured to rotate with respect to the at least one lock ring 36 while the at least one lock ring 36 does not rotate. As noted hereinbefore, the engagement portion 22 can be a stand-alone component that is separable from the torque tool 18.

The interlock sleeve 46 can define a plurality of interior grooves 46b for engagement with the at least one lock ring 36. Further, the interlock sleeve 46 includes a plurality of radially extending outward exterior teeth 46a. As such, the interlock sleeve 46 rotationally couples the lower part 26 and the at least one lock ring 36 together. Additionally, a portion of the interlock sleeve 46 is coaxially disposed between the plurality of tabs 26b and the socket 24 and the at least one lock ring 36 can be coaxially disposed between the interlock sleeve 46 and the socket 24.

The plurality of castles 36a’ of the at least one lock ring 36 can be at least partially received in the plurality of interior grooves 46b of the interlock sleeve 46 to prevent relative rotation between the at least one lock ring 36 and the interlock sleeve 46. Further, a number of the plurality of castles 36a’ of the at least one lock ring 36 is equal to a number of the plurality of interior grooves 46b of the interlock sleeve 46. Such an arrangement provided for a compact assembly so that the stack drive assembly 10 can be deployed in compact locations in which other assemblies could not be utilized.

Each of the plurality of castles 36a’ of the at least one lock ring 36 defines a castle height extending in a direction parallel to the socket axis 38. Each of the plurality of interior grooves 46b of the interlock sleeve 46 defines an interior groove height extending in the direction parallel to the socket axis 38. The castle height is greater than the interior groove height. Because of this, less components are required to be utilized for the stack drive assembly 10 to be operable.

Each of the plurality of recesses 26a of the lower part 26 defines a recess height extending in a direction parallel to the socket axis 38. Each of the plurality of exterior teeth 46a of the interlock sleeve 46 defines a tooth height extending in the direction parallel to the socket axis 38. The recess height is equal to the tooth height.

The stack drive assembly 10 provides numerous advantages. For example, the stack drive assembly 10 allows the torque tool 18 to be used in a variety of orientations that would otherwise not be possible. Notably, there are several environments in which the torque tool 18 could not be safely used when the fastener assembly is inverted. Such orientation would require the user to manually hold the torque tool 18 and stack drive assembly 10 flush against the reaction washer 12 to maintain sufficient mating. Additional limitations can occur when the torque tool 18 and stack drive assembly 10 are placed horizontally against the face of the reaction washer 12.

With the weight of larger versions of the torque tool 18 and stack drive assembly 10 exceeding 100 pounds, the ability to maintain a perpendicular orientation to the flange face and reaction washer 12 can cause the engagement of the stack drive assembly 10 and reaction washer 12 to become misaligned and only partially engaged, thus damaging the reaction washer 12 and stack drive assembly 10.

The quick connect stack drive assembly 10 can include a spring loaded "posi-lock" feature to connect flush and plumb to the reaction washer 12. The quick connect stack drive assembly 10 can include the spring loaded lock-on sleeve 32 to confirm positive lock and not a partial lock onto the reaction washer 12. The quick connect stack drive assembly 10 can define a passage that extends through the entire assembly so that extended length fasteners or threaded rods do not interfere with the ability of the stack drive assembly 10 to connect with the associated nut 16. The quick connect stack drive assembly 10 can have the same mating geometry as the torque tool 18 so that the tool size doesn't have to be changed to operate on a given reaction washer size.

For any given reaction washer size, the torque tool 18 can connect to the reaction washer 12 itself in standard horizontal orientations and vertical orientations and with the quick connect stack drive assembly 10 it can connect to inverted or upside-down applications without having to change the tool size. The quick connect stack drive assembly 10 can be made so as to fit in a radially restrictive environment in which the torque tool 18 might not otherwise fit.

The quick connect stack drive assembly 10 can be positively connected to the reaction washer 12 and torque tool 18 quickly via a quick connect feature, thereby providing a hands-free operation.

The quick connect stack drive assembly 10 is applicable for all inverted bolting applications and all applications that require a smaller radial encroachment into an area with an adjacent fastener or obstruction. The hands-free operation capability provides for maximum safety.

The quick connect stack drive assembly 10 includes the socket 24 and lock-on sleeve 32, that allows for the rotation of the associated nut 16 when the resulting threaded rod (as in the case with a threaded rod and nut) passes thru the center of the assembly 10. The driver 40 mounted to the thru hole socket 24 which matches the fastener size being turned and the quick connect spring loaded cap which holds the quick connect stack drive assembly 10 onto the washer 12 and torque tool 18 to allow for hands-free operation.

A stack drive assembly has been described above with particularity. Modifications and alterations will occur to those upon reading and understanding the preceding detailed description. The invention, however, is not limited to only the embodiments described above. Instead, the invention is broadly defined by the appended claims and the equivalents thereof.

1. A stack drive assembly, comprising:
a socket configured to slidingly engage an associated nut so as to define a socket axis, wherein the socket engages the associated nut for paired rotational movement;
a driver defining a drive shape and a drive size and the associated nut defining a nut shape and a nut size, the drive shape and the drive size of the driver being the same as the nut shape and the nut size of the associated nut, wherein the driver is rotationally coupled to the socket; and
at least one lock ring that is rotationally independent from the driver, wherein the at least one lock ring is configured for engagement with an associated engagement portion of an associated torque tool, wherein the driver is configured to rotate with respect to the at least one lock ring while the at least one lock ring does not rotate.

2. The stack drive assembly of claim 1, wherein the socket includes an upper end and a lower end disposed at opposite ends thereof along the socket axis, the upper end defining a plurality of socket splines primarily extending in a direction along the socket axis, the plurality of socket splines being disposed on an exterior of the upper end of the socket, and wherein an interior of the lower end defines a plurality surfaces that are angularly offset from one another about the socket axis so as to engage the associated nut.

3. The stack drive assembly of claim 2, wherein the driver includes an interior face that defines a plurality of drive splines that slidingly engage the plurality of socket splines of the upper end of the socket so as to rotationally couple the driver and the socket together.

4. The stack drive assembly of claim 2, wherein the upper end of the socket is disposed coaxially interior to the driver.

5. The stack drive assembly of claim 2, the lower end of the socket defining a maximum outer diameter of the socket and the upper end of the socket defining a minimum outer diameter of the socket, wherein the socket includes a shoulder portion that defines a shoulder outer diameter that is less than the maximum outer diameter and greater than the minimum outer diameter.

6. The stack drive assembly of claim 5, wherein the at least one lock ring defines a lock ring inner diameter that is greater than the shoulder outer diameter so that the shoulder portion of the socket can coaxially pass through the at least one lock ring, and wherein the socket is rotationally independent from the at least one lock ring.

7. The stack drive assembly of claim 1, wherein the at least one lock ring includes a first lock ring and a second lock ring that are spaced from one another along the socket axis.

8. The stack drive assembly of claim 7, wherein the driver is disposed along the socket axis so as to be between the first lock ring and the second lock ring.

9. The stack drive assembly of claim 1, further comprising an interlock sleeve that defines a plurality of interior grooves for engagement with the at least one lock ring, wherein the interlock sleeve includes a plurality of radially extending outward exterior teeth.

10. The stack drive assembly of claim 9, further comprising a lower part that is disposed coaxially exterior to the socket, the lower part including a top and a bottom disposed at opposite ends thereof along the socket axis, wherein the lower part includes a plurality of tabs that upwardly extend from the top so as to define a plurality of recesses therebetween for receipt of the plurality of exterior teeth of the interlock sleeve so as to prevent relative rotation between the lower part and the interlock sleeve.

11. The stack drive assembly of claim 10, wherein the at least one lock ring includes a plurality of castles that radially extend outward so as to be at least partially received in the plurality of interior grooves of the interlock sleeve to prevent relative rotation between the at least one lock ring and the interlock sleeve.

12. The stack drive assembly of claim 11, wherein the interlock sleeve rotationally couples the lower part and the at least one lock ring together.

13. The stack drive assembly of claim 11, wherein the plurality of castles of the at least one lock ring are configured to engage the lower part and the associated engagement portion of the associated torque tool.

14. The stack drive assembly of claim 11, wherein each of the plurality of castles of the at least one lock ring defines a castle height extending in a direction parallel to the socket axis and each of the plurality of interior grooves of the interlock sleeve defines an interior groove height extending in the direction parallel to the socket axis, and wherein the castle height is greater than the interior groove height.

15. The stack drive assembly of claim 11, wherein a number of the plurality of castles of the at least one lock ring is equal to a number of the plurality of interior grooves of the interlock sleeve.

16. The stack drive assembly of claim 10, wherein each of the plurality of recesses of the lower part defines a recess height extending in a direction parallel to the socket axis and each of the plurality of exterior teeth of the interlock sleeve defines a tooth height extending in the direction parallel to the socket axis, and wherein the recess height is equal to the tooth height.

17. The stack drive assembly of claim 16, wherein a number of the plurality of recesses of the lower part is equal to a number of the plurality of exterior teeth.

18. The stack drive assembly of claim 10, wherein a portion of the interlock sleeve is coaxially disposed between the plurality of tabs and the socket.

19. The stack drive assembly of claim 10, wherein the at least one lock ring is coaxially disposed between the interlock sleeve and the socket.

20. The stack drive assembly of claim 1, wherein the at least one lock ring defines a lock ring inner diameter that is configured to permit passage of an associated threaded element that threadingly receives the associated nut.
